(19) United States
(12) Patent Application Publication
(10) Pub. No.: US 2022/0027864 A1
(43) Pub. Date: Jan. 27, 2022

(54) Analysis Method for Closed-Loop Supply Chain with Dual Recycling Channels

(71) Applicant: Harbin University of Commerce, Harbin City (CN)

(72) Inventors: Shizhen Bai, Harbin City (CN); Xuelian Zhang, Harbin City (CN)

(73) Assignee: Harbin University of Commerce, Harbin City (CN)

(21) Appl. No.: 17/196,252

(22) Filed: Mar. 9, 2021

(30) Foreign Application Priority Data
Jul. 27, 2020 (CN) 202010732735.9

(51) Int. Cl. G06Q 10/00; G06Q 10/06; G06Q 30/02

(52) U.S. Cl. CPC G06Q 10/30; G06Q 30/0206; G06Q 10/06315

(57) ABSTRACT

The present disclosure provides an analysis method for a closed-loop supply chain (CLSC) with dual recycling channels. The analysis method includes: step S1: constructing recycling function models for dual recycling channels; step S2: constructing a decision model for a non-subsidized CLSC with dual recycling channels and a decision model for a subsidized CLSC with dual recycling channels respectively; step S3: obtaining optimal decisions of a manufacturer, the retailer and the online recycling platform in the non-subsidized CLSC with dual recycling channels and optimal decisions of the manufacturer, the retailer and the online recycling platform in the subsidized CLSC with dual recycling channels; and step S4: determining an influence law of a subsidy on the optimal decisions of the manufacturer, the retailer and the online recycling platform in the CLSC with dual recycling channels through a comparative analysis.

### CROSS-REFERENCE TO RELATED APPLICATIONS

This application claims priority to Chinese Patent Application having serial number 202010732735.9, filed on Jul. 27, 2020. The entirety of which is incorporated by reference herein.

### BACKGROUND OF THE INVENTION

### Field of the Invention

The present disclosure relates to the technical field of applications based on big data, in particular to an analysis method for a closed-loop supply chain (CLSC) with dual recycling channels.

### Description of the Related Art

The massive pile-up of waste electrical and electronic products has quickly plunged China into a severe predicament of environmental destruction and waste of resources, which has aroused social attention. Nowadays, China is vigorously promoting the integration of the recycling industry and Internet technology, and many online recycling platforms have emerged in the recycling industry. In order to expand the diversified recycling channels, the manufacturer commissions the retailer to recycle and also cooperates with the online recycling platform, thereby building dual (online and offline) recycling channels. This satisfies the diverse needs of consumers, who can freely choose the recycling channels according to their preferences. In addition, in order to better regulate recycling and remanufacturing, the manufacturer is encouraged to take the initiative to recycle and process end-of-life electrical and electronic products, and a fixed subsidy is given to the manufacturer based on the amount of waste products that are finally dismantled and processed [1]. Since economic motivation is one of the important factors that affect the active participation of consumers in recycling, companies are in urgent need to make better pricing decisions to attract consumers. However, corporate decisions will inevitably be affected by subsidies.

Many scholars have conducted research on the pricing decisions of the closed-loop supply chain (CLSC). Wang Wenbin et al. considered the effect of fairness concerns on CLSC decisions based on the recycling of third-party recyclers. Atasu et al. studied the influences of different recycling cost structures on the choice and decision of three recycling channels. Ma et al. established a pricing model in which different companies are responsible for recycling. These studies were all based on single recycling channels. Regarding the pricing decisions of the CLSC with a structure of dual recycling channels, Zhao et al. studied equilibrium pricing and member profit decisions under three single-recycling modes and three hybrid-recycling modes based on different value ranges of the intensity of recycling competition. Zheng Benrong et al. studied the choice of the manufacturer for an optimal alliance strategy in the event of joint recycling of the manufacturer and a third party. Li Meiying et al. established a retailer-led pricing decision model based on the recycling of the manufacturer and retailer. Xu Lang et al. studied the pricing and coordinated decision-making of the CLSC by considering the competition of the recycling channels. In reality, various subsidy policies greatly promote the recycling of waste electrical and electronic products, and directly affect the pricing decisions of various enterprises. Cheng Faxin, et al. conducted research on the pricing and profit decisions of the CLSC by considering the consumer's green preference when differential weight subsidies are implemented for the manufacturer and the consumer. Zhao Jinghua et al. studied the impacts of different subsidy targets on the pricing strategy and revenue of each member in the CLSC. Cheng Faxin et al. discussed pricing and coordinated decision-making of the CLSC with uncertainty in the quality of the recycled products based on the recycling subsidy policy. The above studies all focused on traditional recycling channels without taking into consideration the recycling mode of the online recycling platform based on Internet technology.

With the advent of the “Internet+” boom, various forms of online recycling platforms have gradually emerged and been widely used. In recent years, some scholars have begun to consider the existence of the online recycling model. Zhu Xiaodong et al. established a game pricing model for the joint recycling of distributor and online recycler with differences in recycling costs. Wang Yuyan et al. established an E-CLSC structure composed of a manufacturer and an online platform responsible for publishing sales and recycling information to make decisions on pricing and service level. Although these studies involved the recycling mode of the online recycling platform, they did not consider the impact of consumer behavior. Li Chunfa et al. considered the consumer's preference for the online recycling channel, and studied the optimal pricing and profit decisions under several different recycling channels. On this basis, Feng et al. discussed the decision and coordination of the reverse supply chain (RSC) in the structure of recycling channels. However, none of the above studies considered the subsidy policy.

### SUMMARY OF THE INVENTION

In order to solve the above-mentioned technical problems, the present disclosure provides an analysis method for a closed-loop supply chain (CLSC) with dual recycling channels.

The technical solution adopted in the present disclosure is as follows:

An analysis method for a CLSC with dual recycling channels is provided, where the analysis method includes the following steps:

step S1: constructing recycling function models for dual recycling channels based on a consumer's preference over a recycling mode of an online recycling platform and transaction costs of the consumer in a recycling mode of a retailer;

step S2: constructing a decision model for a non-subsidized CLSC with dual recycling channels and a decision model for a subsidized CLSC with dual recycling channels respectively based on the recycling function models;

step S3: solving the decision model for the non-subsidized CLSC with dual recycling channels and the decision model for the subsidized CLSC with dual recycling channels respectively by using a backward induction method, to obtain optimal decisions of a manufacturer, the retailer and the online recycling platform in the non-subsidized CLSC with dual recycling channels and optimal decisions of the manufacturer, the retailer and the online recycling platform in the subsidized CLSC with dual recycling channels;

step S4: determining an influence law of a subsidy on the optimal decisions of the manufacturer, the retailer and the online recycling platform in the CLSC with dual recycling channels through a comparative analysis according to a solution result of step S3; and

step S5: adjusting an amount of the subsidy according to an analysis result of step S4, and establishing a fund allocation and monitoring system to monitor the allocation of a subsidy fund to the manufacturer, the retailer and the online recycling platform.

Preferably, in step 1, the recycling function models for dual recycling channels are constructed as follows:

step S101: assuming that different consumers have different perceived value v of a same waste product and obey a uniform distribution in [0,Qₒ], where Qₒ represents a total number of consumers in a recycling market; Qᵢ represents a recycling volume in a recycling mode i; i=r,t, which respectively represent the recycling mode of the retailer and the recycling mode of the online recycling platform; deriving a consumer utility in the recycling mode of the retailer as Uᵣ=pᵣ−v−k and a consumer utility in the recycling mode of the online recycling platform as Uₜ=pₜ−ϕv according to a recycling form of the consumer in dual recycling channels, where ϕ represents a consumer's preference coefficient, ϕ>1; k represents a transaction cost of the consumer participating in recycling through the retailer, pᵣ and pₜ respectively represent a recycling price of the retailer and a recycling price of the online recycling platform, b>pᵣ, b>pₜ; b represents a transfer payment price paid by the manufacturer to the retailer and the online recycling platform for buying back a waste product from the retailer and the online recycling platform;

step S102: constructing recycling function models according to the consumer utility functions in the recycling mode of the retailer and the recycling mode of the online recycling platform determined in step S101:

a recycling volume of the retailer:

$${Q}_{r} = \frac{ϕ ( {p}_{r} - k ) - {p}_{t}}{ϕ - 1} \qquad ( 1 )$$

a recycling volume of the online recycling platform:

$${Q}_{r} = \frac{{p}_{t} - {p}_{r} + k}{ϕ - 1} \qquad ( 2 )$$

a total recycling volume of a system: Q=pᵣ−k (3).

Preferably, in step 2, the CLSC with dual recycling channels is composed of the manufacturer, the retailer, the online recycling platform and the consumer; the manufacturer serves as a leader of the game and is responsible for production and remanufacturing with a new material and a reusable part, with a unit cost being cₙ and cᵣ respectively, Δ=cₙ−cᵣ>0; a product is wholesaled to the retailer at a wholesale price of w; the retailer is responsible for selling the product to the consumer at a price of p.

Preferably, the decision model for the non-subsidized CLSC with dual recycling channels includes:

an objective function of the manufacturer:

$${max {\prod }_{m}^{N}}_{( {w}^{N} , {b}^{N} )} = ( {w}^{N} - {c}_{n} ) ( a - {p}^{N} ) + ( Δ - {b}^{N} ) ( {p}_{r}^{N} - k ) s . t . {p}_{r}^{N} - k > \frac{{p}_{t}^{N}}{ϕ} \qquad ( 4 )$$

an objective function of the retailer:

$${max {\prod }_{r}^{N}}_{( {p}^{N} , {p}_{r}^{N} )} = ( {p}^{N} - {w}_{n} ) ( a - {p}^{N} ) + \frac{( {b}^{N} - {p}_{r}^{N} ) [ ϕ ( {p}_{r}^{N} - k ) - {p}_{t}^{N} ]}{ϕ - 1} \qquad ( 5 )$$

an objective function of the online recycling platform:

$${max {\prod }_{t}^{N}}_{( {p}_{t}^{N} )} = ( {b}^{N} - {p}_{t}^{N} ) ( \frac{{p}_{t}^{N} - {p}_{r}^{N} + k}{ϕ - 1} ) \qquad ( 6 )$$

these models are solved as follows:

first, finding a first-order derivative of Eq. (6) with respect to pₜ^{N} according to the backward induction method, and equating to 0 to yield

$${p}_{t}^{N} = \frac{{b}^{N} + {p}_{r}^{N} - k}{2} ;$$

then, substituting pₜ^{N} into Eq. (5) to find a first-order partial derivative with respect to p^{N} and pᵣ^{N}, equating to 0 to yield

$${p}^{N} = \frac{a + {w}^{N}}{2} and {p}_{r}^{N} = \frac{2 ϕ {b}^{N} + 2 ϕ k - k}{2 ( 2 ϕ - 1 )} ;$$

substituting pₜ^{N}, p^{N} and pᵣ^{N} into Eq. (4), and applying Kuhn-Tucker (K-T) conditions, then:

$$L = ( {w}^{N} - {c}_{n} ) ( a - {p}^{N} ) + ( Δ - {b}^{N} ) ( {p}_{r}^{N} - k ) + λ ( {p}_{r}^{N} - k - \frac{{p}_{t}^{N}}{ϕ} ) s . t . {p}_{r}^{N} - k > \frac{{p}_{t}^{N}}{ϕ} ;$$

$$\frac{\partial L}{\partial {w}^{N}} = \frac{a + {c}_{n} - 2 {w}^{N}}{2} = 0 ;$$

$$\frac{\partial L}{\partial {b}^{N}} = \frac{2 ϕ ( Δ - 2 {b}^{N} ) + k ( 2 ϕ - 1 )}{2 ( 2 ϕ - 1 )} + \frac{λ ( ϕ - 1 )}{2 ϕ} = 0 ;$$

$$λ [ \frac{4 {ϕ}^{2} {b}^{N} - 6 ϕ {b}^{N} + 2 {b}^{N} - 4 {ϕ}^{2} k + 4 ϕ k - k}{4 ϕ ( 2 ϕ - 1 )} ] = 0 , \\ λ \geq 0 ;$$

according to the K-T conditions:

(1) if λ>0,

$${w}^{{N}^{*}} = \frac{a + {c}_{n}}{2} , \\ {b}^{{N}^{*}} = \frac{2 Δϕ + k ( 2 ϕ - 1 )}{4 ϕ} ;$$

(2) if λ>0,

$${w}^{{N}^{*}} = \frac{a + {c}_{n}}{2} , \\ {b}^{{N}^{*}} = \frac{k ( 2 ϕ - 1 )}{2 ( ϕ - 1 )} ,$$

where in this case, Qᵣ^{N}=0, that is, the retailer has no recycling volume; however, this situation does not exist; therefore, an optimal wholesale price of the manufacturer is

$${w}^{{N}^{*}} = \frac{a + {c}_{n}}{2} ,$$

and an optimal transfer payment price of the manufacturer is

$${b}^{{N}^{*}} = \frac{2 Δϕ + k ( 2 ϕ - 1 )}{4 ϕ} ;$$

substituting

$${w}^{{N}^{*}} = \frac{a + {c}_{n}}{2}$$

$$and$$

$${b}^{{N}^{*}} = \frac{2 Δϕ + k ( 2 ϕ - 1 )}{4 ϕ}$$

into p^{N} and pᵣ^{N} to obtain an optimal sales price of the retailer as

$${p}^{{N}^{*}} = \frac{3 a + {c}_{n}}{4}$$

and an optimal recycling price of the retailer as

$${p}_{r}^{{N}^{*}} = \frac{2 Δϕ + 3 k ( 2 ϕ - 1 )}{4 ( 2 ϕ - 1 )} ;$$

substituting

$${b}^{{N}^{*}} = \frac{2 Δϕ + k ( 2 ϕ - 1 )}{4 ϕ}$$

$$and$$

$${p}_{r}^{{N}^{*}} = \frac{2 Δϕ + 3 k ( 2 ϕ - 1 )}{4 ( 2 ϕ - 1 )}$$

into pₜ^{N} to obtain an optimal recycling price of the online recycling platform as

$${p}_{t}^{{N}^{*}} = \frac{2 Δϕ ( 3 ϕ - 1 ) + k ( 2 ϕ - 1 ) ( ϕ - 1 )}{8 ϕ ( 2 ϕ - 1 )} ;$$

substituting these optimal solutions into D^{N}, Qᵣ^{N} and Qₜ^{N} to obtain an optimal market demand

$${D}^{{N}^{*}} = \frac{a - {c}_{n}}{4} ,$$

an optimal recycling volume of the retailer

$${Q}_{r}^{{N}^{*}} = \frac{2 Δϕ ( ϕ - 1 ) - k ( 2 ϕ - 1 ) ( ϕ + 1 )}{8 ϕ ( ϕ - 1 )}$$

and an optimal recycling volume of the online recycling platform

$${Q}_{t}^{{N}^{*}} = \frac{2 Δϕ ( ϕ - 1 ) + k ( 2 ϕ - 1 ) ( 3 ϕ - 1 )}{8 ϕ ( ϕ - 1 ) ( 2 ϕ - 1 )} ,$$

where D=a−p; D represents a market demand; p represents a sales price; a represents a potential maximum possible market demand; summing

$${Q}_{r}^{{N}^{*}} = \frac{2 Δϕ ( ϕ - 1 ) - k ( 2 ϕ - 1 ) ( ϕ + 1 )}{8 ϕ ( ϕ - 1 )}$$

$$and$$

$${Q}_{t}^{{N}^{*}} = \frac{2 Δϕ ( ϕ - 1 ) + k ( 2 ϕ - 1 ) ( 3 ϕ - 1 )}{8 ϕ ( ϕ - 1 ) ( 2 ϕ - 1 )}$$

to obtain an optimal recycling volume of the system

$${Q}^{{N}^{*}} = \frac{2 Δϕ - k ( 2 ϕ - 1 )}{4 ( 2 ϕ - 1 )} ;$$

finally, obtaining:

an optimal profit of the manufacturer:

$${Π}_{m}^{{N}^{*}} = \frac{{( a - {c}_{n} )}^{2}}{8} + \frac{{[ 2 Δϕ - k ( 2 ϕ - 1 ) ]}^{2}}{16 ϕ ( 2 ϕ - 1 )} \qquad ( 7 )$$

an optimal profit of the retailer:

$${\prod }_{r}^{{N}^{*}} = \frac{{( a - {c}_{n} )}^{2}}{16} + \frac{{[ k ( 2 ϕ - 1 ) ( ϕ + 1 ) - 2 Δ ϕ ( ϕ - 1 ) ]}^{2}}{32 {ϕ}^{2} ( ϕ - 1 ) ( 2 ϕ - 1 )} \qquad ( 8 )$$

an optimal profit of the online recycling platform:

$${\prod }_{t}^{{N}^{*}} = \frac{{[ 2 Δ ϕ ( ϕ - 1 ) + k ( 2 ϕ - 1 ) ( 3 ϕ - 1 ) ]}^{2}}{64 {ϕ}^{2} ( ϕ - 1 ) {( 2 ϕ - 1 )}^{2}} \qquad ( 9 )$$

where, a superscript N represents non-subsidized; * represents an optimal solution; Πᵢ represents a profit of an enterprise i; i=m,r,t, which represent the manufacturer, the retailer and the online recycling platform, respectively; b represents a transfer payment price; w represents a wholesale price.

Preferably, the decision model for the subsidized CLSC with dual recycling channels includes:

an objective function of the manufacturer:

$${max}_{( {w}^{Y} , {b}^{Y} )} {\prod }_{m}^{Y} = ( {w}^{Y} - {c}_{n} ) ( a - {p}^{Y} ) + ( Δ + g - {b}^{Y} ) ( {p}_{r}^{Y} - k ) s . t . {p}_{r}^{Y} - k > \frac{{p}_{t}^{Y}}{ϕ} \qquad ( 10 )$$

an objective function of the retailer:

$${max}_{( {p}^{Y} , {p}_{r}^{Y} )} {\prod }_{r}^{Y} = ( {p}^{Y} - {w}^{Y} ) ( a - {p}^{Y} ) + \frac{( {b}^{Y} - {p}_{r}^{Y} ) [ ϕ ( {p}_{r}^{Y} - k ) - {p}_{t}^{Y} ]}{ϕ - 1} \qquad ( 11 )$$

an objective function of the online recycling platform:

$${max}_{( {p}_{t}^{Y} )} {\prod }_{t}^{Y} = ( {b}^{Y} - {p}_{t}^{Y} ) ( \frac{{p}_{t}^{Y} - {p}_{r}^{Y} + k}{ϕ - 1} ) \qquad ( 12 )$$

these models are solved as follows:

first, finding a first-order derivative of Eq. (12) with respect to pₜ^{Y} according to the backward induction method, and equating to 0 to yield

$${p}_{t}^{Y} = \frac{{b}^{Y} + {p}_{r}^{Y} - k}{2} ;$$

then, substituting pₜ^{Y} into Eq. (11) to find a first-order partial derivative with respect to p^{Y} and pᵣ^{Y}, and equating to 0 to yield

$${p}^{Y} = \frac{a + {w}^{Y}}{2} and {p}_{r}^{Y} = \frac{2 ϕ {b}^{Y} + 2 ϕ k - k}{2 ( 2 ϕ - 1 )} ;$$

substituting pₜ^{Y}, p^{Y} and pᵣ^{Y} into Eq. (10), and applying K-T conditions, then:

$$L = ( {w}^{Y} - {c}_{n} ) ( a - {p}^{Y} ) + ( Δ + g - {b}^{Y} ) ( {p}_{r}^{Y} - k ) + λ ( {p}_{r}^{Y} - k - \frac{{p}_{t}^{Y}}{ϕ} ) s . t . {p}_{r}^{Y} - k > \frac{{p}_{t}^{Y}}{ϕ} ;$$

$$\frac{\partial L}{\partial {w}^{Y}} = \frac{a + {c}_{n} - 2 {w}^{Y}}{2} = 0 ;$$

$$\frac{\partial L}{\partial b} = \frac{2 ϕ ( Δ - 2 b + g ) + k ( 2 ϕ - 1 )}{2 ( 2 ϕ - 1 )} + \frac{λ ( ϕ - 1 )}{2 ϕ} = 0 ;$$

$$λ [ \frac{4 {ϕ}^{2} b - 6 ϕ b + 2 b - 4 {ϕ}^{2} k + 4 ϕ k - k}{4 ϕ ( 2 ϕ - 1 )} ] = 0 , λ \geq 0 .$$

according to the K-T conditions:

(1) if λ>0,

$${b}^{{Y}^{*}} = \frac{2 ϕ ( Δ + g ) + k ( 2 ϕ - 1 )}{4 ϕ} , {w}^{{Y}^{*}} = \frac{a + {c}_{n}}{2} ;$$

(2) if λ>0,

$${w}^{{Y}^{*}} = \frac{a + {c}_{n}}{2} , {b}^{{Y}^{*}} = \frac{k ( 2 ϕ - 1 )}{2 ( ϕ - 1 )} ,$$

where in this case, Qᵣ^{Y*}=0, that is, the retailer has no recycling volume, therefore, an optimal wholesale price of the manufacturer is

$${w}^{{Y}^{*}} = \frac{a + {c}_{n}}{2} ,$$

and an optimal transfer payment price of the manufacturer is

$${b}^{{Y}^{*}} = \frac{2 ϕ ( Δ + g ) + k ( 2 ϕ - 1 )}{4 ϕ} ;$$

substituting

$${w}^{{Y}^{*}} = \frac{a + {c}_{n}}{2} and {b}^{{Y}^{*}} = \frac{2 ϕ ( Δ + g ) + k ( 2 ϕ - 1 )}{4 ϕ}$$

and into p^{Y} and pₜ^{Y} to obtain an optimal sales price of the retailer as

$${p}^{{Y}^{*}} = \frac{3 a + {c}_{n}}{4}$$

and an optimal recycling price of the retailer as

$${p}_{r}^{{Y}^{*}} = \frac{2 ϕ ( Δ + g ) + 3 k ( 2 ϕ - 1 )}{4 ( 2 ϕ - 1 )} ;$$

substituting

$${b}^{{Y}^{*}} = \frac{2 ϕ ( Δ + g ) + k ( 2 ϕ - 1 )}{4 ϕ} and {p}_{r}^{{Y}^{*}} = \frac{2 ϕ ( Δ + g ) + 3 k ( 2 ϕ - 1 )}{4 ( 2 ϕ - 1 )}$$

into pₜ^{Y} to obtain an optimal recycling price of the online recycling platform as

$${p}_{t}^{{Y}^{*}} = \frac{2 ϕ ( Δ + g ) ( 3 ϕ - 1 ) + k ( 2 ϕ - 1 ) ( ϕ - 1 )}{8 ϕ ( 2 ϕ - 1 )} ;$$

substituting these optimal solutions into D^{Y}, Qᵣ^{Y} and Qₜ^{Y} to obtain an optimal market demand

$${D}^{{Y}^{*}} = \frac{a - {c}_{n}}{4} ,$$

an optimal recycling volume of the retailer

$${Q}_{r}^{{Y}^{*}} = \frac{2 ϕ ( Δ + g ) ( ϕ - 1 ) - k ( 2 ϕ - 1 ) ( ϕ + 1 )}{8 ϕ ( ϕ - 1 )}$$

and an optimal recycling volume of the online recycling platform

$${Q}_{t}^{{Y}^{*}} = \frac{2 ϕ ( Δ + g ) ( ϕ - 1 ) - k ( 2 ϕ - 1 ) ( 3 ϕ - 1 )}{8 ϕ ( ϕ - 1 ) ( 2 ϕ - 1 )} ;$$

summing

$${Q}_{r}^{{Y}^{*}} = \frac{2 ϕ ( Δ + g ) ( ϕ - 1 ) - k ( 2 ϕ - 1 ) ( ϕ + 1 )}{8 ϕ ( ϕ - 1 )} and$$

$${Q}_{t}^{{Y}^{*}} = \frac{2 ϕ ( Δ + g ) ( ϕ - 1 ) - k ( 2 ϕ - 1 ) ( 3 ϕ - 1 )}{8 ϕ ( ϕ - 1 ) ( 2 ϕ - 1 )}$$

to obtain an optimal total recycling volume of the system

$${Q}^{{Y}^{*}} = \frac{2 ϕ ( Δ + g ) - k ( 2 ϕ - 1 )}{4 ( 2 ϕ - 1 )} ;$$

finally, obtaining:

an optimal profit of the manufacturer:

$${\prod }_{m}^{{Y}^{*}} = \frac{{( a - {c}_{n} )}^{2}}{8} + \frac{{[ 2 ϕ ( Δ + g ) - k ( 2 ϕ - 1 ) ]}^{2}}{16 ϕ ( 2 ϕ - 1 )} \qquad ( 13 )$$

an optimal profit of the retailer:

$${\prod }_{r}^{{Y}^{*}} = \frac{{( a - {c}_{n} )}^{2}}{16} + \frac{{[ k ( 2 ϕ - 1 ) ( ϕ + 1 ) - 2 ϕ ( Δ + g ) ( ϕ - 1 ) ]}^{2}}{32 {ϕ}^{2} ( ϕ - 1 ) ( 2 ϕ - 1 )} \qquad ( 14 )$$

an optimal profit of the online recycling platform:

$${\prod }_{t}^{{Y}^{*}} = \frac{{[ 2 ϕ ( Δ + g ) ( ϕ - 1 ) + k ( 2 ϕ - 1 ) ( 3 ϕ - 1 ) ]}^{2}}{64 {ϕ}^{2} ( ϕ - 1 ) {( 2 ϕ - 1 )}^{2}} \qquad ( 15 )$$

where, a superscript Y represents subsidized; * represents an optimal solution; Πᵢ represents a profit of an enterprise i; i=m,r,t, which represent the manufacturer, the retailer and the online recycling platform, respectively; b represents a transfer payment price; W represents a wholesale price; g represents a fixed subsidy given based on a quantity of waste electrical and electronic products dismantled and processed by the manufacturer.

The present disclosure has the following beneficial effects. The present disclosure constructs recycling functions for dual recycling channel by considering a consumer's preference for a recycling mode of an online recycling platform and a consumer transaction cost under a recycling mode of a retailer. Then the present disclosure establishes decision models for a CLSC with dual recycling channels in subsidized and non-subsidized cases respectively, where the CLSC is composed of a single manufacturer, the retailer and the online recycling platform. The present disclosure analyzes the influences of a subsidy on a recycling price, a transfer payment price, a recycling volume and a profit in the CLSC of dual recycling channels, and adjusts an amount of the subsidy accordingly. In addition, the present disclosure establishes a fund allocation and monitoring system to monitor the allocation of a subsidy fund to the manufacturer, the retailer and the online recycling platform.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and a person of ordinary skill in the art may still derive other accompanying drawings from these accompanying drawings without creative efforts.

FIG. 1 shows a relationship between decision variables of a closed-loop supply chain (CLSC).

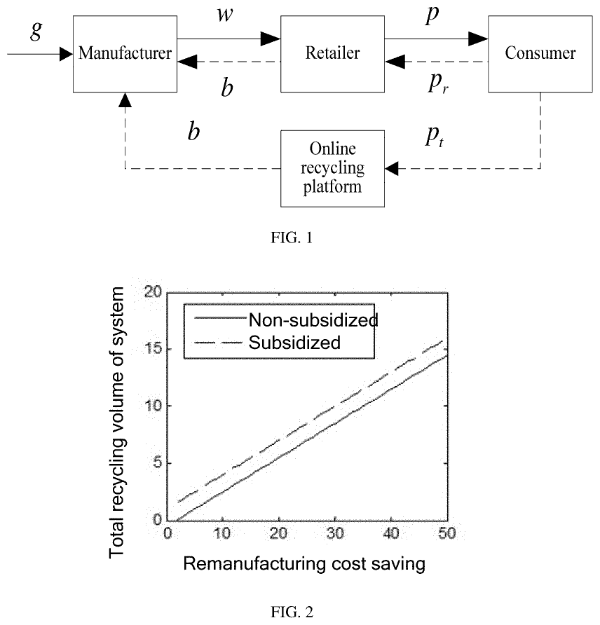

FIG. 2 shows a change trend of a total recycling volume of a system under an influence of a remanufacturing cost saving.

FIG. 3 shows a change trend of a total profit of the system under an influence of the remanufacturing cost saving.

FIGS. 4a, 4b and 4c show change trends of a transfer payment price and a recycling price under influences of a consumer's preference coefficient and transaction costs.

FIGS. 5a, 5b and 5c show influences of the consumer's preference coefficient and transaction costs on profits of members.

### DETAILED DESCRIPTION

The present disclosure is described below in detail with reference to the accompanying drawings.

The present disclosure provides an analysis method for a closed-loop supply chain (CLSC) with dual recycling channels. The analysis method includes the following steps:

Step S1: Construct recycling function models for dual recycling channels based on a consumer's preference over a recycling mode of an online recycling platform and transaction costs of the consumer in a recycling mode of a retailer.

Step S101: Assume that consumers are heterogeneous and different consumers have different perceived value v of a same waste product and obey a uniform distribution in [Qₒ], where Qₒ represents a total number of consumers in a recycling market; Qᵢ represents a recycling volume in a recycling mode i; i=r,t, which respectively represent the recycling mode of the retailer and the recycling mode of the online recycling platform; derive a consumer utility in the recycling mode of the retailer as Uᵣ=pᵣ−v−k and a consumer utility in the recycling mode of the online recycling platform as Uₜ=pₜ−ϕv according to a recycling form of the consumer in dual recycling channels, where ϕ represents a consumer's preference coefficient, ϕ>1, and a smaller value of ϕ indicates a higher consumer's preference for the recycling mode of the online recycling platform; k represents a transaction cost of the consumer participating in recycling through the retailer; pᵣ and pₜ respectively represent a recycling price of the retailer and a recycling price of the online recycling platform, b>pᵣ, b>pₜ; b represents a transfer payment price paid by the manufacturer to the retailer and the online recycling platform for buying back a waste product from the retailer and the online recycling platform.

Step S102: Construct recycling function models according to the consumer utility functions in the recycling mode of the retailer and the recycling mode of the online recycling platform determined in Step S101:

a recycling volume of the retailer:

$${Q}_{r} = \frac{ϕ ( {p}_{r} - k ) - {p}_{t}}{ϕ - 1} \qquad ( 1 )$$

a recycling volume of the online recycling platform:

$${Q}_{t} = \frac{{p}_{t} - {p}_{r} + k}{ϕ - 1} \qquad ( 2 )$$

a total recycling volume of a system: Q=pᵣ−k (3).

Step S2: Construct a decision model for a non-subsidized CLSC with dual recycling channels and a decision model for a subsidized CLSC with dual recycling channels respectively based on the recycling function models, where the CLSC with dual recycling channels is composed of the manufacturer, the retailer, the online recycling platform and the consumer, the manufacturer serves as a leader of the game and is responsible for production and remanufacturing with a new material and a reusable part, with a unit cost being cₙ and cᵣ respectively; because remanufacturing has a cost saving advantage, Δ=cₙ−cᵣ>0; products produced with the new material and the reusable part are exactly the same, and are wholesaled to the retailer at a wholesale price of w; the retailer is responsible for selling the products to the consumer at a price of p.

Step S3: Solve the decision model for the non-subsidized CLSC with dual recycling channels and the decision model for the subsidized CLSC with dual recycling channels respectively by using a backward induction method, to obtain optimal decisions of the manufacturer, the retailer and the online recycling platform in the non-subsidized CLSC with dual recycling channels and optimal decisions of the manufacturer, the retailer and the online recycling platform in the subsidized CLSC with dual recycling channels.

Step S4: Determine an influence law of a subsidy on the optimal decisions of the manufacturer, the retailer and the online recycling platform in the CLSC with dual recycling channels through a comparative analysis according to a solution result of Step S3.

Step S5: Adjust an amount of the subsidy according to an analysis result of Step S4, and establish a fund allocation and monitoring system to monitor the allocation of a subsidy fund to the manufacturer, the retailer and the online recycling platform.

In Steps S2 and S3, the decision model for the non-subsidized CLSC with dual recycling channels includes:

an objective function of the manufacturer:

$${max}_{( {w}^{N} , {b}^{N} )} , {\prod }_{m}^{N} = ( {w}^{N} - {c}_{n} ) ( a - {p}^{N} ) + ( Δ - {b}^{N} ) ( {p}_{r}^{N} - k ) s . t . {p}_{r}^{N} - k > \frac{{p}_{t}^{N}}{ϕ} \qquad ( 4 )$$

an objective function of the retailer:

$${max}_{( {p}^{N} , {p}_{r}^{N} )} {\prod }_{r}^{N} = ( {p}^{N} - {w}^{N} ) ( a - {p}^{N} ) + \frac{( {b}^{N} - {p}_{r}^{N} ) [ ϕ ( {p}_{r}^{N} - k ) - {p}_{t}^{N} ]}{ϕ - 1} \qquad ( 5 )$$

an objective function of the online recycling platform:

$${max}_{( {p}_{t}^{N} )} {\prod }_{t}^{N} = ( {b}^{N} - {p}_{t}^{N} ) ( \frac{{p}_{t}^{N} - {p}_{r}^{N} + k}{ϕ - 1} ) . \qquad ( 6 )$$

These models are solved as follows:

First, find a first-order derivative of Eq. (6) with respect to pₜ^{N} according to the backward induction method, and equate to 0 to yield

$${p}_{t}^{N} = \frac{{b}^{N} + {p}_{r}^{N} - k}{2} .$$

Then, substitute pₜ^{N} into Eq. (5) to find a first-order partial derivative with respect to p^{N} and pᵣ^{N}, and equate to 0 to yield

$${p}^{N} = \frac{a + {w}^{N}}{2}$$

$$and$$

$${p}_{r}^{N} = \frac{2 ϕ {b}^{N} + 2 ϕ k - k}{2 ( 2 ϕ - 1 )} .$$

Substitute pₜ^{N}, p^{N} and pᵣ^{N} into Eq. (4), and apply Kuhn-Tucker (K-T) conditions, then:

$$L = ( {w}^{N} - {c}_{n} ) ( a - {p}^{N} ) + ( Δ - {b}^{N} ) ( {p}_{r}^{N} - k ) + λ ( {p}_{r}^{N} - k - \frac{{p}_{f}^{N}}{ϕ} ) \cdot s . t . {p}_{r}^{N} - k > \frac{{p}_{t}^{N}}{ϕ} ; \\ \frac{\partial L}{\partial {w}^{N}} = \frac{a + {c}_{n} - 2 {w}^{N}}{2} = 0 ; \\ \frac{\partial L}{\partial {b}^{N}} = \frac{2 ϕ ( Δ - 2 {b}^{N} ) + k ( 2 ϕ - 1 )}{2 ( 2 ϕ - 1 )} + \frac{λ ( ϕ - 1 )}{2 ϕ} = 0 ; \\ λ [ \frac{4 {ϕ}^{2} {b}^{N} - 6 ϕ {b}^{N} + 2 {b}^{N} - 4 {ϕ}^{2} k + 4 ϕ k - k}{4 ϕ ( 2 ϕ - 1 )} ] = 0 , \\ λ \geq 0. \qquad$$

According to the K-T conditions:

(1) if λ>0,

$${w}^{{N}^{*}} = \frac{a + {c}_{n}}{2} , \\ {b}^{{N}^{*}} = \frac{2 Δϕ + k ( 2 ϕ - 1 )}{4 ϕ} .$$

(2) if λ>0,

$${w}^{{N}^{*}} = \frac{a + {c}_{n}}{2} , \\ {b}^{{N}^{*}} = \frac{k ( 2 ϕ - 1 )}{2 ( ϕ - 1 )} .$$

In this case, Qᵣ^{N*}=0, that is, the retailer has no recycling volume. However, this situation does not exist. Therefore, an optimal wholesale price of the manufacturer is

$${w}^{{N}^{*}} = \frac{a + {c}_{n}}{2} ,$$

and an optimal transfer payment price of the manufacturer is

$${b}^{{N}^{*}} = \frac{2 Δϕ + k ( 2 ϕ - 1 )}{4 ϕ} .$$

Substitute

$${w}^{{N}^{*}} = \frac{a + {c}_{n}}{2} , \\ and$$

$${b}^{{N}^{*}} = \frac{2 Δϕ + k ( 2 ϕ - 1 )}{4 ϕ}$$

and into p^{N} and pᵣ^{N} to obtain an optimal sales price of the retailer as

$${p}^{{N}^{*}} = \frac{3 a + {c}_{n}}{4}$$

and an optimal recycling price of the retailer as

$${p}_{r}^{{N}^{*}} = \frac{2 Δϕ + 3 k ( 2 ϕ - 1 )}{4 ( 2 ϕ - 1 )} .$$

Substitute

$${b}^{{N}^{*}} = \frac{2 Δϕ + k ( 2 ϕ - 1 )}{4 ϕ}$$

$$and$$

$${p}_{r}^{{N}^{*}} = \frac{2 Δϕ + 3 k ( 2 ϕ - 1 )}{4 ( 2 ϕ - 1 )}$$

into pₜ^{N} to obtain an optimal recycling price of the online recycling platform as

$${p}_{t}^{{N}^{*}} = \frac{2 Δϕ ( 3 ϕ - 1 ) + k ( 2 ϕ - 1 ) ( ϕ - 1 )}{8 ϕ ( 2 ϕ - 1 )} .$$

Substitute these optimal solutions into D^{N}, Qᵣ^{N} and Qₜ^{N} to obtain an optimal market demand

$${D}^{{N}^{*}} = \frac{a - {c}_{n}}{4} ,$$

an optimal recycling volume of the retailer

$${Q}_{r}^{{N}^{*}} = \frac{2 Δϕ ( ϕ - 1 ) - k ( 2 ϕ - 1 ) ( ϕ + 1 )}{8 ϕ ( ϕ - 1 )}$$

and an optimal recycling volume of the online recycling platform

$${Q}_{r}^{{N}^{*}} = \frac{2 Δϕ ( ϕ - 1 ) + k ( 2 ϕ - 1 ) ( 3 ϕ - 1 )}{8 ϕ ( ϕ - 1 ) ( 2 ϕ - 1 )} ,$$

where D=a−p; D represents a market demand; p represents a sales price; a represents a potential maximum possible market demand; sum

$${Q}_{r}^{{N}^{*}} = \frac{2 Δϕ ( ϕ - 1 ) - k ( 2 ϕ - 1 ) ( ϕ + 1 )}{8 ϕ ( ϕ - 1 )}$$

$$and$$

$${Q}_{t}^{{N}^{*}} = \frac{2 Δϕ ( ϕ - 1 ) + k ( 2 ϕ - 1 ) ( 3 ϕ - 1 )}{8 ϕ ( ϕ - 1 ) ( 2 ϕ - 1 )}$$

to obtain an optimal recycling volume of the system

$${Q}^{{N}^{*}} = \frac{2 Δϕ - k ( 2 ϕ - 1 )}{4 ( 2 ϕ - 1 )} .$$

Finally, obtain:

an optimal profit of the manufacturer:

$${Π}_{m}^{{N}^{*}} = \frac{{( a - {c}_{n} )}^{2}}{8} + \frac{{[ 2 Δϕ - k ( 2 ϕ - 1 ) ]}^{2}}{16 ϕ ( 2 ϕ - 1 )} \qquad ( 7 )$$

an optimal profit of the retailer:

$${Π}_{r}^{{N}^{*}} = \frac{{( a - {c}_{n} )}^{2}}{16} + \frac{{[ k ( 2 ϕ - 1 ) ( ϕ + 1 ) - 2 Δ ϕ ( ϕ - 1 ) ]}^{2}}{32 {ϕ}^{2} ( ϕ - 1 ) ( 2 ϕ - 1 )} \qquad ( 8 )$$

an optimal profit of the online recycling platform:

$${max {\prod }_{t}^{N}}_{( {p}_{t}^{N} )} = ( {b}^{N} - {p}_{t}^{N} ) ( \frac{{p}_{t}^{N} - {p}_{r}^{N} + k}{ϕ - 1} ) . \qquad ( 9 )$$

In the above equations, a superscript N represents non-subsidized; * represents an optimal solution; Πᵢ represents a profit of an enterprise i; i=m,r,t, which represent the manufacturer, the retailer and the online recycling platform, respectively.

The decision model for the subsidized CLSC with dual recycling channels includes:

an objective function of the manufacturer:

$${max {\prod }_{m}^{Y}}_{( {w}^{Y} , {b}^{Y} )} = ( {w}^{Y} - {c}_{n} ) ( a - {p}^{Y} ) + ( Δ + g - {b}^{Y} ) ( {p}_{r}^{Y} - k ) s . t . {p}_{r}^{Y} - k > \frac{{p}_{t}^{Y}}{ϕ} \qquad ( 10 )$$

an objective function of the retailer:

$${max {\prod }_{m}^{Y}}_{( {p}^{Y} , {p}_{t}^{Y} )} = ( {p}^{Y} - {w}^{Y} ) ( a - {p}^{Y} ) + \frac{( {b}^{Y} - {p}_{r}^{Y} ) [ ϕ ( {p}_{r}^{Y} - k ) - {p}_{t}^{Y} ]}{ϕ - 1} \qquad ( 11 )$$

an objective function of the online recycling platform:

$${max}_{( {p}_{t}^{Y} )} {\prod }_{t}^{Y} = ( {b}^{Y} - {p}_{t}^{Y} ) ( \frac{{p}_{t}^{Y} - {p}_{r}^{Y} + k}{ϕ - 1} ) . \qquad ( 12 )$$

These models are solved as follows:

First, find a first-order derivative of Eq. (12) with respect to pₜ^{Y} according to the backward induction method, and equate to 0 to yield

$${p}_{t}^{Y} = \frac{{b}^{Y} + {p}_{r}^{Y} - k}{2} ;$$

then, substitute pₜ^{Y} into Eq. (11) to find a first-order partial derivative with respect to p^{Y} and pᵣ^{Y}, and equate to 0 to yield

$${p}^{Y} = \frac{a + {w}^{Y}}{2}$$

$$and$$

$${p}_{r}^{Y} = \frac{2 ϕ {b}^{Y} + 2 ϕ k - k}{2 ( 2 ϕ - 1 )} ;$$

substitute pₜ^{Y}, p^{Y} and pᵣ^{Y} into Eq. (10), and apply K-T conditions, then:

$$L = ( {w}^{Y} - {c}_{n} ) ( a - {p}^{Y} ) + ( Δ + g - {b}^{Y} ) ( {p}_{r}^{Y} - k ) + λ ( {p}_{r}^{Y} - k - \frac{{p}_{t}^{Y}}{ϕ} ) s . t . {p}_{r}^{Y} - k > \frac{{p}_{t}^{Y}}{ϕ} ; \\ \frac{\partial L}{\partial {w}^{Y}} = \frac{a + {c}_{n} - 2 {w}^{Y}}{2} = 0 ; \\ \frac{\partial L}{\partial b} = \frac{2 ϕ ( Δ - 2 b + g ) + k ( 2 ϕ - 1 )}{2 ( 2 ϕ - 1 )} + \frac{λ ( ϕ - 1 )}{2 ϕ} = 0 ; \\ λ [ \frac{4 {ϕ}^{2} b - 6 ϕ b + 2 b - 4 {ϕ}^{2} k + 4 ϕ k - k}{4 ϕ ( 2 ϕ - 1 )} ] = 0 , λ \geq 0. \qquad$$

According to the K-T conditions:

(1) if λ>0,

$${b}^{{Y}^{*}} = \frac{2 ϕ ( Δ + g ) + k ( 2 ϕ - 1 )}{4 ϕ} , \\ {w}^{{Y}^{*}} = \frac{a + {c}_{n}}{2} .$$

(2) if λ>0,

$${w}^{{Y}^{*}} = \frac{a + {c}_{n}}{2} , \\ {b}^{{Y}^{*}} = \frac{k ( 2 ϕ - 1 )}{2 ( ϕ - 1 )} .$$

In this case, Qᵣ^{Y*}=0, that is, the retailer has no recycling volume. Therefore, and optimal wholesale price of the manufacturer is

$${w}^{{Y}^{*}} = \frac{a + {c}_{n}}{2} ,$$

and an optimal transfer payment price of the manufacturer is

$${b}^{{Y}^{*}} = \frac{2 ϕ ( Δ + g ) + k ( 2 ϕ - 1 )}{4 ϕ} .$$

Substitute

$${w}^{{Y}^{*}} = \frac{a + {c}_{n}}{2} and {b}^{{Y}^{*}} = \frac{2 ϕ ( Δ + g ) + k ( 2 ϕ - 1 )}{4 ϕ}$$

into p^{Y} and pᵣ^{Y} to obtain an optimal sales price of the retailer as

$${p}^{{Y}^{*}} = \frac{3 a + {c}_{n}}{4}$$

and an optimal recycling price of the retailer as

$${p}_{r}^{{Y}^{*}} = \frac{2 ϕ ( Δ + g ) + 3 k ( 2 ϕ - 1 )}{4 ( 2 ϕ - 1 )} .$$

Substitute

$${b}^{{Y}^{*}} = \frac{2 ϕ ( Δ + g ) + k ( 2 ϕ - 1 )}{4 ϕ} and$$

$${p}_{r}^{{Y}^{*}} = \frac{2 ϕ ( Δ + g ) + 3 k ( 2 ϕ - 1 )}{4 ( 2 ϕ - 1 )}$$

into pₜ^{Y} to obtain an optimal recycling price of the online recycling platform as

$${p}_{t}^{{Y}^{*}} = \frac{2 ϕ ( Δ + g ) ( 3 ϕ - 1 ) + k ( 2 ϕ - 1 ) ( ϕ - 1 )}{8 ϕ ( 2 ϕ - 1 )} .$$

Substitute these optimal solutions into D^{Y}, Qᵣ^{Y}, and Qₜ^{Y} to obtain an optimal market demand

$${D}^{{Y}^{*}} = \frac{a - {c}_{n}}{4} ,$$

an optimal recycling volume of the retailer

$${Q}_{r}^{{Y}^{*}} = \frac{2 ϕ ( Δ + g ) ( ϕ - 1 ) - k ( 2 ϕ - 1 ) ( ϕ + 1 )}{8 ϕ ( ϕ - 1 )}$$

and an optimal recycling volume of the online recycling platform

$${Q}_{t}^{{Y}^{*}} = \frac{2 ϕ ( Δ + g ) ( ϕ - 1 ) + k ( 2 ϕ - 1 ) ( 3 ϕ - 1 )}{8 ϕ ( ϕ - 1 ) ( 2 ϕ - 1 )} ;$$

sum

$${Q}_{r}^{{Y}^{*}} = \frac{2 ϕ ( Δ + g ) ( ϕ - 1 ) - k ( 2 ϕ - 1 ) ( ϕ + 1 )}{8 ϕ ( ϕ - 1 )} and$$

$${Q}_{t}^{{Y}^{*}} = \frac{2 ϕ ( Δ + g ) ( ϕ - 1 ) + k ( 2 ϕ - 1 ) ( 3 ϕ - 1 )}{8 ϕ ( ϕ - 1 ) ( 2 ϕ - 1 )}$$

to obtain an optimal total recycling volume of the system

$${Q}^{{Y}^{*}} = \frac{2 ϕ ( Δ + g ) - k ( 2 ϕ - 1 )}{4 ( 2 ϕ - 1 )} .$$

Finally, obtain:

an optimal profit of the manufacturer:

$${Π}_{m}^{{Y}^{*}} = \frac{{( a - {c}_{n} )}^{2}}{8} + \frac{{[ 2 ϕ ( Δ + g ) - k ( 2 ϕ - 1 ) ]}^{2}}{16 ϕ ( 2 ϕ - 1 )} \qquad ( 13 )$$

an optimal profit of the retailer:

$${Π}_{r}^{{Y}^{*}} = \frac{{( a - {c}_{n} )}^{2}}{16} + \frac{{[ k ( 2 ϕ - 1 ) ( ϕ + 1 ) - 2 ϕ ( Δ + g ) ( ϕ - 1 ) ]}^{2}}{32 {ϕ}^{2} ( ϕ - 1 ) ( 2 ϕ - 1 )} \qquad ( 14 )$$

an optimal profit of the online recycling platform:

$${Π}_{t}^{{Y}^{*}} = \frac{{[ 2 ϕ ( Δ + g ) ( ϕ - 1 ) + k ( 2 ϕ - 1 ) ( 3 ϕ - 1 ) ]}^{2}}{64 {ϕ}^{2} ( ϕ - 1 ) {( 2 ϕ - 1 )}^{2}} \qquad ( 15 )$$

In the above equations, a superscript Y represents subsidized; * represents an optimal solution; Πᵢ represents a profit of an enterprise i; i=m,r,t, which represent the manufacturer, the retailer and the online recycling platform, respectively; g represents a fixed subsidy given based on a quantity of waste electrical and electronic products dismantled and processed by the manufacturer.

An influence law of a subsidy on the optimal decisions of the manufacturer, the retailer and the online recycling platform in the CLSC with dual recycling channels is comparatively analyzed as follows:

(1) In subsidized and non-subsidized cases, the optimal prices of the manufacturer, the retailer and the online recycling platform respectively satisfy the following relationships: w^{Y*}=w^{N*}, b^{Y*}>b^{N*}, p^{Y*}=p^{N*}, pᵣ^{Y*}>pᵣ^{N*} and pₜ^{Y*}>pₜ^{N*}. When there is a subsidy, the transfer payment price of the manufacturer and the recycling prices of the retailer and the online recycling platform are higher than those without a subsidy. This is because the implementation of the subsidy policy allows the manufacturer to directly profit from the dismantling and processing business, so the manufacturer has the incentive to increase the transfer payment price paid to the retailer and the online recycling platform so as to mobilize the enthusiasm of the two to participate in recycling. This further increases the recycling prices of the retailer and the online recycling platform, and fully protects the interests of the consumer.

(2) In subsidized and non-subsidized cases, the optimal demand of the manufacturer, the optimal recycling volume of the retailer and the online recycling platform and the optimal total recycling volume of the system respectively satisfy the following relationships: D^{Y*}=D^{N*}, Qᵣ^{Y*}>Qᵣ^{N*}, Qₜ^{Y*}>Qₜ^{N*} and Q^{Y*}>Q^{N*}. Compared with the non-subsidized case, in the subsidized case, the recycling volume of the retailer and the online recycling platform is increased, and the total recycling volume of the system is correspondingly increased. This is because the implementation of the subsidy policy allows the manufacturer to voluntarily increase the transfer payment price so as to transfer part of the revenue to the retailer and the online recycling platform. At this time, in order to obtain higher profits, the retailer and the online recycling platform will be more active to recycle waste products from the consumer by increasing recycling prices. Obviously, economic motivation is a key factor that affects the consumer's enthusiasm for participating in recycling, and the increase in the final recycling price encourages the consumer to voluntarily deliver idle waste products, which increases the volume of waste products recycled.

(3) In the subsidized and non-subsidized cases, the optimal decisions of the members satisfy the following relationships: Πₘ^{Y*}>Πₘ^{N*}, Πᵣ^{Y*}>Πᵣ^{N*} and Πₜ^{Y*}>Πₜ^{N*}. Compared with the non-subsidized case, in the subsidized case, the profits of the manufacturer, the retailer and the online recycling platform all increase in the subsidized case. This shows that the subsidy policy targeting the manufacturer is conducive to improving the profit of the manufacturer, mobilizing the initiative and enthusiasm of the manufacturer to participate in recycling and processing, and also conducive to increasing the profits of the retailer and the online recycling platform. Therefore, the subsidy policy can successfully promote the development of the recycling and remanufacturing industry, thereby solving the problems of resource waste and environmental pollution.

As the amount of the subsidy increases, the decision values in the forward sales process do not change; in the reverse recycling process, the optimal transfer payment price of the manufacturer and the optimal recycling prices and optimal recycling volume of the retailer and the online recycling platform gradually increase, and the optimal total recycling volume of the system gradually increases.

As the amount of the subsidy increases, the optimal decisions of the members all gradually increase.

As the amount of the subsidy increases, the transfer payment price of the manufacturer and the recycling prices of the retailer and the online recycling platform increase accordingly. This stimulates more consumers to actively participate in recycling, correspondingly increasing the volume of waste products recycled, and ultimately enabling the companies to obtain higher returns. It can be seen that the increase in the subsidy can effectively support the sound development of the recycling and processing industry, and can achieve a win-win situation for economic and environmental benefits. Therefore, subsidization is one of the most direct and effective ways to promote the green recycling of waste electrical and electronic products. The department should increase the amount of the subsidy based on the actual situation of recycling and processing, and establish a fund allocation and monitoring system to monitor the allocation of the subsidy fund to the manufacturer, the retailer and the online recycling platform.

In order to carry out more in-depth research, the present disclosure discusses the influences of a remanufacturing cost saving, a consumer transaction cost and a consumer's preference coefficient on a CLSC with dual recycling channels with reference to calculation examples by using Matrix Laboratory (MATLAB) software.

### Influences of Remanufacturing Cost Saving

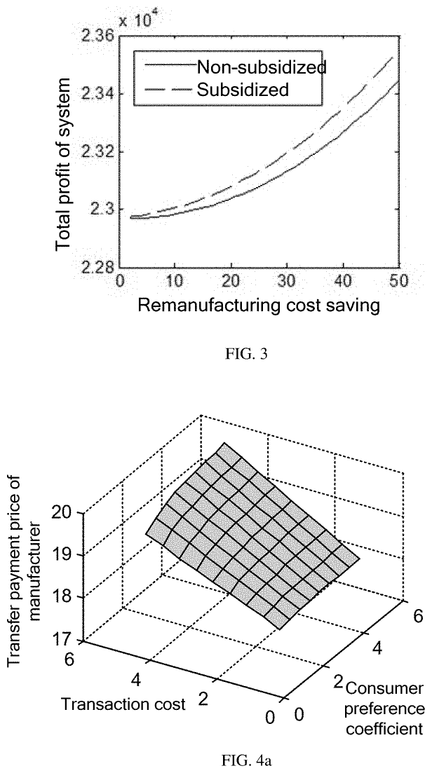

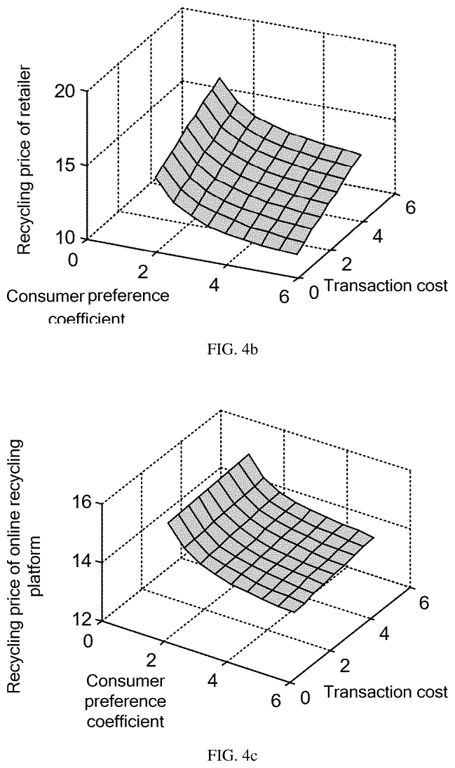

The influences of the remanufacturing cost saving on the total recycling volume and total profit in the CLSC system with dual recycling channels are analyzed by taking a=400, cₙ=50 g=5, ϕ=3, k=2 and Δ∈[2,50], as shown in FIGS. 2 and 3.

FIG. 2 shows that the total recycling volume of the CLSC system increases as the remanufacturing cost saving increases. A higher remanufacturing cost saving indicates a higher benefit for the manufacturer from remanufacturing. Therefore, the manufacturer is more willing to transfer part of the revenue to the retailer and the online recycling platform to encourage the retailer and the online recycling platform to actively participate in recycling. At this time, the retailer and the online recycling platform are also willing to encourage the consumer to take the initiative to deliver idle waste products by increasing their recycling prices, so that the total recycling volume of the system increases. In addition, it can be seen from the figure that the total recycling volume of the system in the subsidized case is always greater than that in the non-subsidized case, which further verifies the effectiveness of subsidies in promoting the development of the recycling industry. It can be seen from FIG. 3 that the total profit of the CLSC system increases as the remanufacturing cost saving increases, and a greater remanufacturing cost saving leads to a higher total profit of the system in the subsidized case than that in the non-subsidized case. This is because the remanufacturing cost saving and the subsidy are a source of increased profits. When the cost saved by the manufacturer from remanufacturing and the amount of the subsidy increase, the enthusiasm of the manufacturer to participate in recycling and remanufacturing also increases. Although the retailer and the online recycling platform do not directly enjoy the support from the subsidies, they can obtain a great financial incentive from the manufacturer. It can be seen that the subsidy to the manufacturer increases the profits of the manufacturer, the retailer and the online recycling platform, which can achieve the purpose of saving resources and protecting the environment, and make economic and ecological benefits balanced.

### Influences of Consumer's Preference Coefficient and Transaction Cost

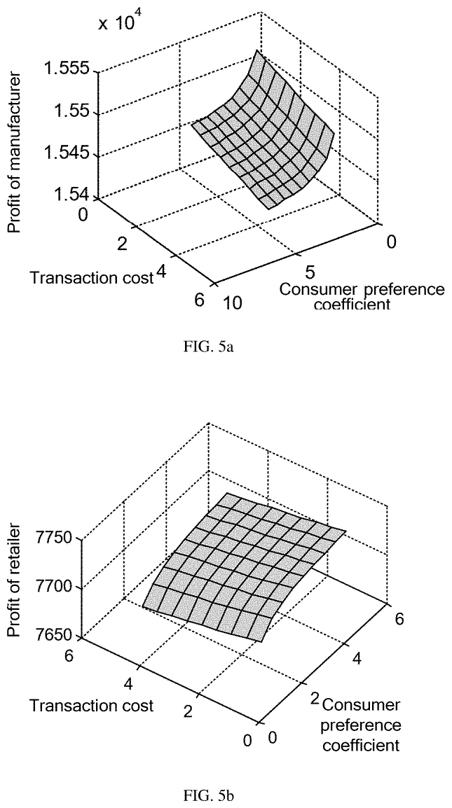

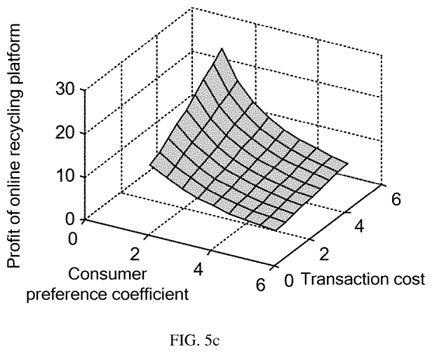

The influences of the consumer's preference coefficient and transaction cost on the recycling prices and corporate profits are further analyzed by taking Δ=30, ϕ∈[1.5.5.5] and k∈[1.5], as shown in FIGS. 4 and 5.

FIG. 4(a) shows that, for the manufacturer, when the consumer's preference coefficient is constant, as the transaction cost increases, the transfer payment price shows a large upward trend; when the transaction cost is constant, as the consumer's preference coefficient increases, that is, as the consumer's preference for the recycling mode of the online recycling platform decreases, the transfer payment price shows a small upward trend. FIG. 4(b) shows that for the retailer, the recycling price of the retailer is directly proportional to the transaction cost of the consumer, and inversely proportional to the consumer's preference coefficient. That is, as the transaction cost increases, the recycling price of the retailer gradually increases; as the consumer's preference coefficient increases, the recycling price of the retailer gradually decreases. FIG. 4(c) shows that for the online recycling platform, when the consumer's preference coefficient is constant, the recycling price of the online recycling platform increases with the increase in the transaction cost; when the transaction cost is constant, the recycling price of the online recycling platform decreases as the consumer's preference coefficient increases. These figures show that a higher consumer transaction cost incurred under the recycling mode of the retailer results in worse recycling experience. At this time, the manufacturer will largely increase the transfer payment price to encourage the retailer and the online recycling platform to increase the recycling price, which increases the initiative of the consumer to participate in recycling. When the consumer's preference coefficient increases, that is, when the consumer's preference for the recycling mode of the online recycling platform decreases, although the manufacturer increases the transfer payment price, the retailer and the online recycling platform both reduce the recycling price. It can be seen that the reduction of the consumer's preference for the recycling mode of the online recycling platform leads to a reduction in the recycling price, which harms the consumer's recycling interests and is not conducive to the development of the recycling industry.

FIGS. 5(a) to (c) show that when the consumer's preference coefficient is constant, with the increase of the transaction cost, the optimal profit of the online recycling platform gradually increases, while the optimal decisions of the retailer and the manufacturer gradually decrease; when the transaction cost is constant, as the consumer's preference coefficient increases, the optimal profit of the retailer gradually increases, while the optimal decisions of the online recycling platform and the manufacturer gradually decrease. This shows that the increase in the transaction cost makes the online recycling platform profitable but causes a loss to the profit of the retailer; the increase in the consumer's preference coefficient benefits the retailer but causes a loss to the profit of the online recycling platform. The increases in the transaction cost and the consumer's preference coefficient are not conducive to the manufacturer. Therefore, in order to achieve the simultaneous development of economic and environmental benefits, for the online recycling platform, it is necessary to increase the consumer's preference for the online recycling mode by enhancing publicity, making the quality inspection process transparent and ensuring the security of user privacy data. For the retailer, it is necessary to simplify the transaction process, improve the recycling service provided to the consumer and enhance the recycling experience. For the manufacturer, it is necessary to transfer more revenue to the retailer and the online recycling platform by increasing the transfer payment price to encourage the retailer and the online recycling platform to actively participate in recycling.

The present disclosure analyzes the recycling channel selection behavior of the consumer by taking the subsidy policy into consideration, and compares the CLSC decision models in subsidized and non-subsidized cases. The present disclosure further discusses the effects of the remanufacturing cost saving, the consumer's preference coefficient and the transaction cost on the CLSC of dual recycling channels by analyzing through calculation examples. The study finds that:

(1) The subsidy policy increasing the transfer payment price of the manufacturer and the recycling prices of the retailer and the online recycling platform. This benefits and attracts the consumer to actively participate in recycling, and effectively increases the recycling volume of the system and the profits of the member companies, thereby achieving both economic and environmental benefits. Therefore, the amount of the subsidy should be increased according to the actual situation to promote the development of the recycling and remanufacturing industry of waste electrical and electronic products in the form of financial support, so as to improve resource recovery and utilization, and to reduce environmental pollution.

(2) As the remanufacturing cost saving increases, the total recycling volume and total profit of the system both increase, and compared with the non-subsidized case, the total recycling volume and total profit of the system are higher in the subsidized case. This shows that the increases in the subsidy and the remanufacturing cost saving can effectively increase the volume of waste electrical and electronic products recycled and the benefits of the entire CLSC. Thus, while ensuring the steady improvement in the economic benefits of enterprises, it also promotes the efficient recycling of resources.

(3) As the consumer transaction cost incurred in the recycling mode of the retailer increases, the transfer payment price of the manufacturer and the recycling prices of the retailer and the online recycling platform all increase. As the consumer's preference coefficient increases, that is, as the consumer's preference for the recycling mode of the online recycling platform reduces, the transfer payment price of the manufacturer increases, while the recycling prices of the retailer and the online recycling platform decrease. The increases in the consumer transaction cost and preference coefficient have different effects on the profits of the retailer and the online recycling platform, but both lead to a lower profit of the manufacturer. It can be seen that the increases in the consumer transaction cost and preference coefficient are not conducive to the development of the recycling industry. Therefore, for the online recycling platform, it is necessary to continuously increase the publicity of the online recycling model, increase the research and development and investment in operation support technologies, make full use of emerging technologies such as big data analysis, the Internet of Things (IoT) and cloud computing, strengthen data removal technology, make the recycling quality inspection process transparent, and to enhance the consumer's preference for the online recycling mode. For the retailer, it is necessary to reduce the transaction cost of the consumer in the recycling mode of the retailer by providing convenient recycling services, simplifying recycling procedures and increasing recycling outlets.

The above described are merely intended to illustrate the technical solutions of the present disclosure, rather than to construct a limitation to the present disclosure. Those of ordinary skill in the art may make other modifications or equivalent replacements to the technical solutions of the present disclosure without departing from the spirit and scope of the technical solutions of the present disclosure, but such modifications or equivalent replacements should fall within the scope defined by the claims of the present disclosure.

What is claimed is:

1. An analysis method for a closed-loop supply chain (CLSC) with dual recycling channels, wherein the analysis method comprises the following steps:
step S1: constructing recycling function models for dual recycling channels based on a consumer's preference over a recycling mode of an online recycling platform and transaction costs of the consumer in a recycling mode of a retailer.
step S2: constructing a decision model for a non-subsidized CLSC with dual recycling channels and a decision model for a subsidized CLSC with dual recycling channels respectively based on the recycling function models;
step S3: solving the decision model for the non-subsidized CLSC with dual recycling channels and the decision model for the subsidized CLSC with dual recycling channels respectively by using a backward induction method, to obtain optimal decisions of a manufacturer, the retailer and the online recycling platform in the non-subsidized CLSC with dual recycling channels and optimal decisions of the manufacturer, the retailer and the online recycling platform in the subsidized CLSC with dual recycling channels;
step S4: determining an influence law of a subsidy on the optimal decisions of the manufacturer, the retailer and the online recycling platform in the CLSC with dual recycling channels through a comparative analysis according to a solution result of step S3; and
step S5: adjusting an amount of the subsidy according to an analysis result of step S4, and establishing a fund allocation and monitoring system to monitor the allocation of a subsidy fund to the manufacturer, the retailer and the online recycling platform.

2. The analysis method for a CLSC with dual recycling channels according to claim 1, wherein in step 1, the recycling function models for dual recycling channels are constructed as follows:
step S101: assuming that different consumers have different perceived value v of a same waste product and obey a uniform distribution in [0,Qₒ], wherein Qₒ represents a total number of consumers in a recycling market; Qᵢ represents a recycling volume in a recycling mode i; i=r,t, which respectively represent the recycling mode of the retailer and the recycling mode of the online recycling platform; deriving a consumer utility in the recycling mode of the retailer as Uᵣ=pᵣ−v−k and a consumer utility in the recycling mode of the online recycling platform as Uₜ=pₜ-ϕv according to a recycling form of the consumer in dual recycling channels, wherein ϕ represents a consumer's preference coefficient, ϕ>1; k represents a transaction cost of the consumer participating in recycling through the retailer, pᵣ and pₜ respectively represent a recycling price of the retailer and a recycling price of the online recycling platform, b>pᵣ, b>pₜ; b represents a transfer payment price paid by the manufacturer to the retailer and the online recycling platform for buying back a waste product from the retailer and the online recycling platform;
step S102: constructing recycling function models according to the consumer utility functions in the recycling mode of the retailer and the recycling mode of the online recycling platform determined in step S101:
a recycling volume of the retailer:
$${Q}_{r} = \frac{ϕ ( {p}_{r} - k ) - {p}_{t}}{ϕ - 1} \qquad ( 1 )$$
a recycling volume of the online recycling platform:
$${Q}_{t} = \frac{{p}_{t} - {p}_{r} + k}{ϕ - 1} \qquad ( 2 )$$
a total recycling volume of a system: Q=pᵣ−k (3).

3. The analysis method for a CLSC with dual recycling channels according to claim 2, wherein in step 2, the CLSC with dual recycling channels is composed of the manufacturer, the retailer, the online recycling platform and the consumer; the manufacturer serves as a leader of the game and is responsible for production and remanufacturing with a new material and a reusable part, with a unit cost being cₙ and cᵣ respectively, Δ=cₙ−cᵣ>0; a product is wholesaled to the retailer at a wholesale price of w; the retailer is responsible for selling the product to the consumer at a price of p.

4. The analysis method for a CLSC with dual recycling channels according to claim 3, wherein
the decision model for the non-subsidized CLSC with dual recycling channels comprises:
an objective function of the manufacturer:
$${max {\prod }_{m}^{N}}_{( {w}^{N} , {b}^{N} )} = ( {w}^{N} - {c}_{n} ) ( a - {p}^{N} ) + ( Δ - {b}^{N} ) ( {p}_{r}^{N} - k ) \\ s . t . {p}_{r}^{N} - k > \frac{{p}_{t}^{N}}{ϕ} \qquad ( 4 )$$
an objective function of the retailer:
$${max {\prod }_{r}^{N}}_{( {p}^{N} , {p}_{r}^{N} )} = ( {p}^{N} - {w}^{N} ) ( a - {p}^{N} ) + \frac{( {b}^{N} - {p}_{r}^{N} ) [ ϕ ( {p}_{r}^{N} - k ) - {p}_{t}^{N} ]}{ϕ - 1} \qquad ( 5 )$$
an objective function of the online rec cling platform:
$${max {\prod }_{t}^{N}}_{( {p}_{t}^{N} )} = ( {b}^{N} - {p}_{t}^{N} ) ( \frac{{p}_{t}^{N} - {p}_{r}^{N} + k}{ϕ - 1} ) \qquad ( 6 )$$
these models are solved as follows:
first, finding a first-order derivative of Eq. (6) with respect to pₜ^{N} according to the backward induction method, and equating to 0 to yield
$${p}_{t}^{N} = \frac{{b}^{N} + {p}_{r}^{N} - k}{2} ;$$
then, substituting pₜ^{N} into Eq. (5) to find a first-order partial derivative with respect to p^{N} and pᵣ^{N} and equating to 0 to yield
$${p}^{N} = \frac{a + {w}^{N}}{2} and {p}_{r}^{N} = \frac{2 ϕ {b}^{N} + 2 ϕ k - k}{2 ( 2 ϕ - 1 )} ;$$
substituting pₜ^{N}, p^{N} and pᵣ^{N} into Eq. (4), and applying Kuhn-Tucker (K-T) conditions, then:
$$L = ( {w}^{N} - {c}_{n} ) ( a - {p}^{N} ) + ( Δ - {b}^{N} ) ( {p}_{r}^{N} - k ) + λ ( {p}_{r}^{N} - k - \frac{{p}_{t}^{N}}{ϕ} )$$
$$s . t . {p}_{r}^{N} - k > \frac{{p}_{t}^{N}}{ϕ} ;$$
$$\frac{\partial L}{\partial {w}^{N}} = \frac{a + {c}_{n} - 2 {w}^{N}}{2} = 0 ;$$
$$\frac{\partial L}{\partial {b}^{N}} = \frac{2 ϕ ( Δ - 2 {b}^{N} ) + k ( 2 ϕ - 1 )}{2 ( 2 ϕ - 1 )} + \frac{λ ( ϕ - 1 )}{2 ϕ} = 0 ;$$
$$λ [ \frac{4 {ϕ}^{2} {b}^{N} - 6 ϕ {b}^{N} + 2 {b}^{N} - 4 {ϕ}^{2} k + 4 ϕ k - k}{4 ϕ ( 2 ϕ - 1 )} ] = 0 , λ \geq 0 ;$$
according to the K-T conditions:
$$( 1 ) if λ = 0 , {w}^{{N}^{*}} = \frac{a + {c}_{n}}{2} , {b}^{{N}^{*}} = \frac{2 Δ ϕ + k ( 2 ϕ - 1 )}{4 ϕ} ; \\ ( 2 ) if λ > 0 , {w}^{{N}^{*}} = \frac{a + {c}_{n}}{2} , {b}^{{N}^{*}} = \frac{k ( 2 ϕ - 1 )}{2 ( ϕ - 1 )} , \qquad$$
wherein in this case, Qᵣ^{N*}=0, that is, the retailer has no recycling volume; however, this situation does not exist; therefore, an optimal wholesale price of the manufacturer is
$${w}^{{N}^{*}} = \frac{a + {c}_{n}}{2} ,$$
and an optimal transfer payment price of the manufacturer is
$${b}^{{N}^{*}} = \frac{2 Δϕ + k ( 2 ϕ - 1 )}{4 ϕ} ;$$
substituting
$${w}^{{N}^{*}} = \frac{a + {c}_{n}}{2} and {b}^{{N}^{*}} = \frac{2 Δϕ + k ( 2 ϕ - 1 )}{4 ϕ}$$
into p^{N} and pᵣ^{N} to obtain an optimal sales price of the retailer as
$${p}^{{N}^{*}} = \frac{3 a + {c}_{n}}{4}$$
and an optimal recycling price of the retailer as
$${p}_{r}^{{N}^{*}} = \frac{2 Δϕ + 3 k ( 2 ϕ - 1 )}{4 ( 2 ϕ - 1 )} ;$$
substituting
$${b}^{{N}^{*}} = \frac{2 Δϕ + k ( 2 ϕ - 1 )}{4 ϕ} and {p}_{r}^{{N}^{*}} = \frac{2 Δϕ + 3 k ( 2 ϕ - 1 )}{4 ( 2 ϕ - 1 )}$$
into pₜ^{N} to obtain an optimal recycling price of the online recycling platform as
$${p}_{t}^{{N}^{*}} = \frac{2 Δϕ ( 3 ϕ - 1 ) + k ( 2 ϕ - 1 ) ( ϕ - 1 )}{8 ϕ ( 2 ϕ - 1 )} ;$$
substituting these optimal solutions into D^{N}, Qᵣ^{N} and Qₜ^{N} to obtain an optimal market demand
$${D}^{{N}^{*}} = \frac{a - {c}_{n}}{4} ,$$
an optimal recycling volume of the retailer
$${Q}_{r}^{{N}^{*}} = \frac{2 Δϕ ( ϕ - 1 ) - k ( 2 ϕ - 1 ) ( ϕ + 1 )}{8 ϕ ( ϕ - 1 )}$$
and an optimal recycling volume of the online recycling platform
$${Q}_{t}^{{N}^{*}} = \frac{2 Δϕ ( ϕ - 1 ) + k ( 2 ϕ - 1 ) ( 3 ϕ - 1 )}{8 ϕ ( ϕ - 1 ) ( 2 ϕ - 1 )} ,$$
wherein D=a−p; D represents a market demand; p represents a sales price; a represents a potential maximum possible market demand; summing
$${Q}_{r}^{{N}^{*}} = \frac{2 Δϕ ( ϕ - 1 ) - k ( 2 ϕ - 1 ) ( ϕ + 1 )}{8 ϕ ( ϕ - 1 )} and$$
$${Q}_{t}^{{N}^{*}} = \frac{2 Δϕ ( ϕ - 1 ) + k ( 2 ϕ - 1 ) ( 3 ϕ - 1 )}{8 ϕ ( ϕ - 1 ) ( 2 ϕ - 1 )}$$
to obtain an optimal recycling volume of the system
$${Q}^{{N}^{*}} = \frac{2 Δϕ - k ( 2 ϕ - 1 )}{4 ( 2 ϕ - 1 )} ;$$
finally, obtaining:
an optimal profit of the manufacturer:
$${\prod }_{m}^{{N}^{*}} = \frac{{( a - {c}_{n} )}^{2}}{8} 2 + \frac{{[ 2 Δϕ - k ( 2 ϕ - 1 ) ]}^{2}}{16 ϕ ( 2 ϕ - 1 )} \qquad ( 7 )$$
an optimal profit of the retailer:
$${\prod }_{r}^{{N}^{*}} = \frac{{( a - {c}_{n} )}^{2}}{16} + \frac{{[ k ( 2 ϕ - 1 ) ( ϕ + 1 ) - 2 Δ ϕ ( ϕ - 1 ) ]}^{2}}{32 {ϕ}^{2} ( ϕ - 1 ) ( 2 ϕ - 1 )} \qquad ( 8 )$$
an optimal profit of the online recycling platform:
$${\prod }_{t}^{{N}^{*}} = \frac{{[ 2 Δϕ ( ϕ - 1 ) + k ( 2 ϕ - 1 ) ( 3 ϕ - 1 ) ]}^{2}}{64 {ϕ}^{2} ( ϕ - 1 ) {( 2 ϕ - 1 )}^{2}} \qquad ( 9 )$$
wherein, a superscript N represents non-subsidized; * represents an optimal solution; Πᵢ represents a profit of an enterprise i; i=m,r,t, which represent the manufacturer, the retailer and the online recycling platform, respectively; b represents a transfer payment price; w represents a wholesale price.

5. The analysis method for a CLSC with dual recycling channels according to claim 3, wherein
the decision model for the subsidized CLSC with dual recycling channels comprises:
an objective function of the manufacturer:
$${max}_{( {w}^{Y} , {b}^{Y} )} {\prod }_{m}^{Y} = ( {w}^{Y} - {c}_{n} ) ( a - {p}^{Y} ) + ( Δ + g - {b}^{Y} ) ( {p}_{r}^{Y} - k ) \\ s . t . {p}_{r}^{Y} - k > \frac{{p}_{t}^{Y}}{ϕ} \qquad ( 10 )$$
an objective function of the retailer:
$${max}_{( {p}^{Y} , {p}_{r}^{Y} )} {\prod }_{t}^{Y} = ( {p}^{Y} - {w}^{Y} ) ( a - {p}^{Y} ) + \frac{( {b}^{Y} - {p}_{r}^{Y} ) [ ϕ ( {p}_{r}^{Y} - k ) - {p}_{t}^{Y} ]}{ϕ - 1} \qquad ( 11 )$$
an objective function of the online recycling platform:
$${max}_{( {p}_{t}^{Y} )} {\prod }_{t}^{Y} = ( {b}^{Y} - {p}_{t}^{Y} ) ( \frac{{p}_{t}^{Y} - {p}_{r}^{Y} + k}{ϕ - 1} ) \qquad ( 12 )$$
these models are solved as follows:
first, finding a first-order derivative of Eq. (12) with respect to pᵢ^{Y} according to the backward induction method, and equating to 0 to yield
$${p}_{t}^{Y} = \frac{{b}^{Y} + {p}_{r}^{Y} - k}{2} ;$$
then, substituting pₜ^{Y}. into Eq. (11) to find a first-order partial derivative with respect to p^{Y} and pᵣ^{Y}, and equating to 0 to yield
$${p}^{Y} = \frac{a + {w}^{Y}}{2} and {p}_{r}^{Y} = \frac{2 ϕ {b}^{Y} + 2 ϕ k - k}{2 ( 2 ϕ - 1 )} ;$$
substituting pₜ^{Y}, p^{Y} and pᵣ^{Y}, into Eq. (10), and applying K-T conditions, then:
$$L = ( {w}^{Y} - {c}_{n} ) ( a - {p}^{Y} ) + ( Δ + g - {b}^{Y} ) ( {p}_{r}^{Y} - k ) + λ ( {p}^{Y} - k - \frac{{p}_{t}^{Y}}{ϕ} )$$
$$s . t . {p}_{r}^{Y} - k > \frac{{p}_{t}^{Y}}{ϕ} ;$$
$$\frac{\partial L}{\partial {w}^{Y}} = \frac{a + {c}_{n} - 2 {w}^{Y}}{2} = 0 ;$$
$$\frac{\partial L}{\partial b} = \frac{2 ϕ ( Δ - 2 b + g ) + k ( 2 ϕ - 1 )}{2 ( 2 ϕ - 1 )} + \frac{λ ( ϕ - 1 )}{2 ϕ} = 0 ;$$
$$λ [ \frac{4 {ϕ}^{2} b - 6 ϕ b + 2 b - 4 {ϕ}^{2} k + 4 ϕ k - k}{4 ( 2 ϕ - 1 )} ] = 0 , λ \geq 0.$$
according to the K-T conditions:
$$\begin{matrix}if λ = 0 , {b}^{{Y}^{*}} = \frac{2 ϕ ( Δ + g ) + k ( 2 ϕ - 1 )}{4 ϕ} , {w}^{{Y}^{*}} = \frac{a + {c}_{n}}{2} ; & ( 1 ) \\ if λ > 0 , {w}^{{Y}^{*}} = \frac{a + {c}_{n}}{2} , {b}^{{Y}^{*}} = \frac{k ( 2 ϕ - 1 )}{2 ( ϕ - 1 )} , & ( 2 )\end{matrix}$$
wherein in this case, Qᵣ^{Y*}=0, that is, the retailer has no recycling volume; therefore, an optimal wholesale price of the manufacturer is
$${w}^{{Y}^{*}} = \frac{a + {c}_{n}}{2} ,$$
and an optimal transfer payment price of the manufacturer is
$${b}^{{Y}^{*}} = \frac{2 ϕ ( Δ + g ) + k ( 2 ϕ - 1 )}{4 ϕ} ;$$
substituting
$${w}^{{Y}^{*}} = \frac{a + {c}_{n}}{2} and {b}^{{Y}^{*}} = \frac{2 ϕ ( Δ + g ) + k ( 2 ϕ - 1 )}{4 ϕ}$$
into p^{Y} and pᵣ^{Y} to obtain an optimal sales price of the retailer as
$${p}^{{Y}^{*}} = \frac{3 a + {c}_{n}}{4}$$
and an optimal recycling price of the retailer as
$${p}_{r}^{{Y}^{*}} = \frac{2 ϕ ( Δ + g ) + 3 k ( 2 ϕ - 1 )}{4 ( 2 ϕ - 1 )} ;$$
substituting
$${b}^{{Y}^{*}} = \frac{2 ϕ ( Δ + g ) + k ( 2 ϕ - 1 )}{4 ϕ} and {p}_{r}^{{Y}^{*}} = \frac{2 ϕ ( Δ + g ) + 3 k ( 2 ϕ - 1 )}{4 ( 2 ϕ - 1 )}$$
into pₜ^{Y} to obtain an optimal recycling price of the online recycling platform as
$${p}_{t}^{{Y}^{*}} = \frac{2 ϕ ( Δ g ϕ - 1 ) + k ( 2 ϕ - 1 ) ( ϕ - 1 )}{8 ϕ ( 2 ϕ - 1 )} ;$$
substituting these optimal solutions into D^{Y}, Qᵣ^{Y} and Qₜ^{Y} to obtain an optimal market demand
$${D}^{{Y}^{*}} = \frac{a - {c}_{n}}{4} ,$$
an optimal recycling volume of the retailer
$${Q}_{r}^{{Y}^{*}} = \frac{2 ϕ ( Δ + g ) ( ϕ - 1 ) - k ( 2 ϕ - 1 ) ( ϕ + 1 )}{8 ϕ ( ϕ - 1 )}$$
and an optimal recycling volume of the online recycling platform
$${Q}_{t}^{{Y}^{*}} = \frac{2 ϕ ( Δ + g ) ( ϕ - 1 ) + k ( 2 ϕ - 1 ) ( 3 ϕ - 1 )}{8 ϕ ( ϕ - 1 ) ( 2 ϕ - 1 )} ;$$
summing
$${Q}_{r}^{{Y}^{*}} = \frac{2 ϕ ( Δ + g ) ( ϕ - 1 ) - k ( 2 ϕ - 1 ) ( ϕ + 1 )}{8 ϕ ( ϕ - 1 )} and$$
$${Q}_{t}^{{Y}^{*}} = \frac{2 ϕ ( Δ + g ) ( ϕ - 1 ) + k ( 2 ϕ - 1 ) ( 3 ϕ - 1 )}{8 ϕ ( ϕ - 1 ) ( 2 ϕ - 1 )}$$
to obtain an optimal total recycling volume of the system
$${Q}^{{Y}^{*}} = \frac{2 ϕ ( Δ + g ) - k ( 2 ϕ - 1 )}{4 ( 2 ϕ - 1 )} ;$$
finally, obtaining:
an optimal profit of the manufacturer:
$${\prod }_{m}^{{Y}^{*}} = \frac{{( a - {c}_{n} )}^{2}}{8} 2 + \frac{{[ 2 ϕ ( Δ + g ) - k ( 2 ϕ - 1 ) ]}^{2}}{16 ϕ ( 2 ϕ - 1 )} \qquad ( 13 )$$
an optimal profit of the retailer:
$${\prod }_{r}^{{Y}^{*}} = \frac{{( a - {c}_{n} )}^{2}}{16} + \frac{{[ k ( 2 ϕ - 1 ) ( ϕ + 1 ) - 2 ϕ ( Δ + g ) ( ϕ - 1 ) ]}^{2}}{32 {ϕ}^{2} ( ϕ - 1 ) ( 2 ϕ - 1 )} \qquad ( 14 )$$
an optimal profit of the online recycling platform:
$${\prod }_{t}^{{Y}^{*}} = \frac{{[ 2 ϕ ( Δ + g ) ( ϕ - 1 ) + k ( 2 ϕ - 1 ) ( 3 ϕ - 1 ) ]}^{2}}{64 {ϕ}^{2} ( ϕ - 1 ) {( 2 ϕ - 1 )}^{2}} \qquad ( 15 )$$
wherein, a superscript Y represents subsidized; * represents an optimal solution; Πᵢ represents a profit of an enterprise i; i=m,r,t, which represent the manufacturer, the retailer and the online recycling platform, respectively; b represents a transfer payment price; w represents a wholesale price; g represents a fixed subsidy given based on a quantity of waste electrical and electronic products dismantled and processed by the manufacturer.
